(19) United States
(12) Patent Application Publication
(10) Pub. No.: US 2018/0081231 A1
(43) Pub. Date: Mar. 22, 2018

(54) DISPLAY DEVICES

(71) Applicant: Shenzhen China Star Optoelectronics Technology Co., Ltd., Shenzhen, Guangdong (CN)

(72) Inventor: Quan LI, Shenzhen, Guangdong (CN)

(73) Assignee: Shenzhen China Star Optoelectronics Technology Co., Ltd., Shenzhen, Guangdong (CN)

(21) Appl. No.: 15/038,667

(22) PCT Filed: Apr. 25, 2016
(86) PCT No.: PCT/CN2016/080155

§ 371 Date: May 23, 2016

(30) Foreign Application Priority Data
Apr. 11, 2016 (CN) 201610223258.7

(51) Int. Cl. G02F 1/1333

(52) U.S. Cl. CPC G02F 1/133308; G02F 2001/133322

(57) ABSTRACT

A display device includes a display panel having two protrusion structures arranged on the two sides perpendicular to a horizontal direction. The display device includes two supporting structures supporting and fixing the display panel. The supporting structure includes a base and a guiding rail on the base. The guiding rail engages with the protrusion structure, and the guiding rail covers the protrusion structure being inserted along the guiding rail to latch the display panel within the supporting structure. In this way, the structure of the supporting structure is simple and may be easily installed. The display device may be effectively fixed and the manufacturing cost may be greatly reduced.

### BACKGROUND OF THE INVENTION

### 1. Field of the Invention

The present disclosure relates to display technology, and more particularly to a display device.

### 2. Discussion of the Related Art

Currently liquid crystal devices (LCDs) are developed to be large-scale and thin so as to satisfy users demand.

Usually, the display device may include a display panel, a front housing, a rear housing, and a base. The front housing and the rear housing are assembled to fix the display panel, and then be assembled with the base.

The thickness of the front frame and the rear frame may deteriorate the thin and light design of the display device. Thus, the base of the large-scale display device usually are made by metal and plastic components, which results in a complicated assembling or disassembling process.

### SUMMARY

The present disclosure relates to a display device having a simple support structure for installation. The support structure may effectively fix the display device to reduce the manufacturing cost.

In one aspect, a display device includes: a display panel comprising two protrusion structures on the two sides perpendicular to a horizontal direction; the display device comprises two supporting structures supporting and fixing the display panel; wherein the display panel is a single-side display panel, a transparent display panel or a double-sided display panel, and a length of the protrusion structure is configured in accordance with a center height of the display panel; the supporting structure comprises a base and a guiding rail on the base, the guiding rail engages with the protrusion structure, and the guiding rail covers the protrusion structure being inserted along the guiding rail to latch the display panel within the supporting structure.

Wherein the base and the guiding rail are integrally formed.

Wherein cross-sections of the guiding rail and the protrusion structure are regular polygon.

Wherein cross-sections of the guiding rail and the protrusion structure are rectangular-shaped.

Wherein cross-sections of the guiding rail and the protrusion structure are inverted-trapezium-shaped.

Wherein cross-sections of the guiding rail and the protrusion structure are hemicycle-shaped.

Wherein cross-sections of the guiding rail and the protrusion structure are circular.

Wherein a guiding structure is arranged in a bottom of the display panel, wherein the guiding structure is arranged close to a location of the protrusion structure.

In another aspect, a display device includes: a display panel, wherein the display panel comprising two protrusion structures on the two sides perpendicular to a horizontal direction; the display device comprises two supporting structures supporting and fixing the display panel; wherein the supporting structure comprises a base and a guiding rail on the base, the guiding rail engages with the protrusion structure, and the guiding rail covers the protrusion structure being inserted along the guiding rail to latch the display panel within the supporting structure.

Wherein a length of the protrusion structure is configured in accordance with a center height of the display panel.

Wherein the base and the guiding rail are integrally formed.

Wherein cross-sections of the guiding rail and the protrusion structure are regular polygon.

Wherein cross-sections of the guiding rail and the protrusion structure are rectangular-shaped.

Wherein cross-sections of the guiding rail and the protrusion structure are inverted-trapezium-shaped.

Wherein cross-sections of the guiding rail and the protrusion structure are hemicycle-shaped.

Wherein cross-sections of the guiding rail and the protrusion structure are circular.

Wherein a guiding structure is arranged in a bottom of the display panel, wherein the guiding structure is arranged close to a location of the protrusion structure.

Wherein the display panel is a single-side display panel, a transparent display panel or a double-sided display panel.

In view of the above, two protrusion structures are arranged at two sides of the display panel perpendicular to the horizontal direction. By engaging the guiding rail and the protrusion structures, the display panel is latched within the supporting structure so as to support and fix the display panel.

The supporting structure are arranged at two lateral sides of the display panel, the display panel is latched within the supporting structures by the guiding rail and the protrusion structure, which may reduce the thickness of the display device to some extent. In this way, the structure of the supporting structure is simple and may be easily installed to reduce the human labor. As the supporting structures are arranged at two lateral sides of the display panel, the transparent display panel and the double-sided display panel may be effectively fixed.

### BRIEF DESCRIPTION OF THE DRAWINGS

FIG. 1 is a schematic view of the display device in accordance with one embodiment.

FIG. 2 is a schematic view of the protrusion structure of FIG. 1.

FIG. 3 is a schematic view of the support structure of FIG. 1.

FIG. 4 is a cross sectional view of the protrusion structure in accordance with one embodiment.

### DETAILED DESCRIPTION OF THE EMBODIMENTS

Embodiments of the invention will now be described more fully hereinafter with reference to the accompanying drawings, in which embodiments of the invention are shown.

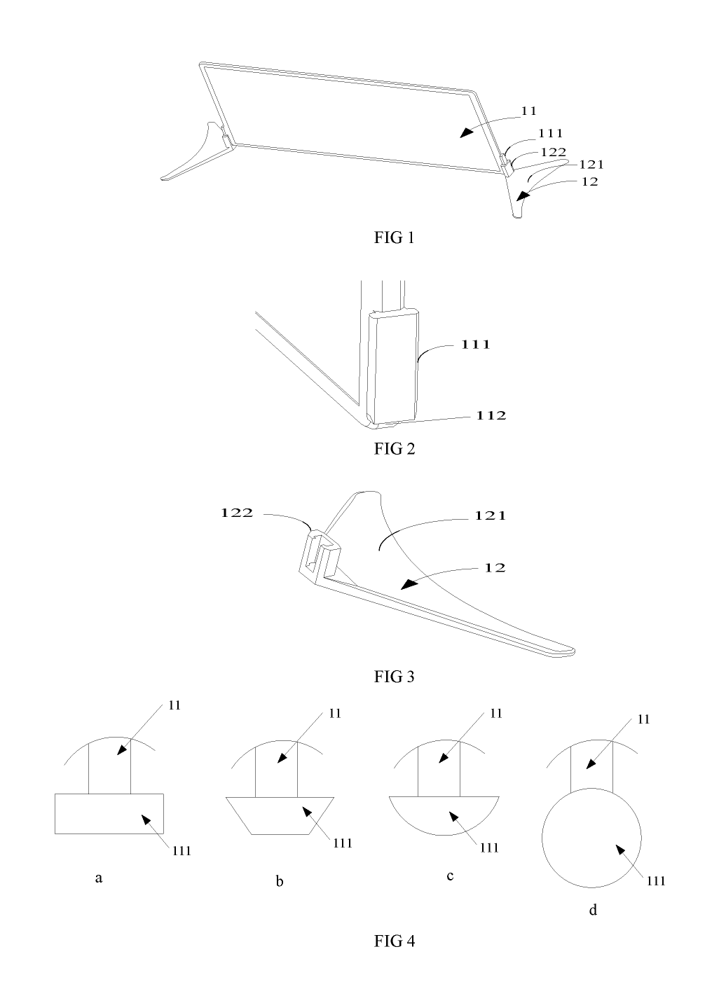

FIG. 1 is a schematic view of the display device in accordance with one embodiment. FIG. 2 is a schematic view of the protrusion structure of FIG. 1. FIG. 3 is a schematic view of the support structure of FIG. 1. The display device includes a display panel 11 and two supporting structures 12 for supporting and fixing the display panel.

The display panel 11 is configured with two protrusion structures 111 at two sides perpendicular to a horizontal direction. The supporting structure 12 includes a base 121 and a guide rail 122 arranged on the base 121.

The guide rail 122 engages with the protrusion structure 111 in a way that the guide rail 122 covers the protrusion structure 111 along the guide rail 122 such that the display panel 11 is latched by the supporting structure 12.

Further, the base 121 and the guide rail 122 on the base 121 are integrally formed.

During an assembly process, the protrusion structures 111 at two sides of the display panel 11 are inserted along the guide rail 122. The guide rails 122 at two sides cooperatively operate with each other such that the guide rail 122 covers the protrusion structures 111 of the display panel 11. In this way, the display panel 11 is latched between the supporting structures 12 via the guide rail 122.

Further, a guiding structure 112 is arranged in a bottom of the display panel 11, and the guiding structure 112 is arranged to be close to the protrusion structures 111.

In an example, the guiding structure 112 is arranged to be close to an edge of the protrusion structure 111. The guiding structure 112 forms a predetermined angle between a horizontal side and the edge of the bottom of the display panel 11. The predetermined angle may be configured in accordance with real scenario, and thus is not limited to the disclosure.

The guiding structure 112 is provided such that the two protrusion structures 111 may be respectively inserted into the guide rails 122 during the assembling process.

In addition, a length of the protrusion structure 111 is configured in accordance with a center height of the display panel 11. The location of the protrusion structure 111 may be configured in accordance with real scenario.

For instance, the length of the protrusion structure 111 may be configured to be, but not limited to, half of the center height of the protrusion structure 111. That is, the length of the protrusion structure 111 may be configured in accordance with real scenario. The only principle is that the supporting may stably support and fix the display panel 11.

In an example, the shapes of the guide rail 122 and the protrusion structure 111 may be regular polygon that can engage with each other.

In an example, the shapes of the guide rail 122 and the protrusion structure 111 may be hemicycle that can engage with each other.

In an example, the shapes of the guide rail 122 and the protrusion structure 111 may be circle that can engage with each other.

FIG. 4 is a cross sectional view of the protrusion structure in accordance with one embodiment. As shown in FIG. 4a, the cross section of the protrusion structure 111 is Rectangular. Corresponding, the shape of the guide rail 122 may be rectangular such that the protrusion structure 111 may be inserted into the guide rail 122.

It can be understood that, in other embodiments, the cross section of the protrusion structure 111 may be, but not limited to, square or hexagon.

As shown in FIG. 4b, the cross section of the protrusion structure 111 is inverted-trapezium-shaped. Correspondingly, the guide rail 122 may be inverted-trapezium-shaped such that the protrusion structure 111 may insert into the guide rail 122.

As shown in FIG. 4c, the cross section of the protrusion structure 111 is hemicycle-shaped. Correspondingly, the guide rail 122 may be hemicycle-shaped such that the protrusion structure 111 may insert into the guide rail 122.

As shown in FIG. 4c, the cross section of the protrusion structure 111 is circular. Correspondingly, the guide rail 122 may be circular such that the protrusion structure 111 may insert into the guide rail 122.

In the embodiment, the display panel 11 of the display device may be a single-sided display panel. In another example, the display panel 11 of the display device may be a transparent display panel, or a double-sided display panel.

In view of the above, the protrusion structures are arranged at two sides of the display panel. The guide rail structure arranged on the support structure covers the protrusion structure being inserted along the guide rail. In this way, the display panel is latched within the support structure such that the support structure supports and fixes the display panel.

As the supporting structures are arranged at two lateral sides of the display panel, the thickness of the display device may be reduced to some extent by latching the display panel within the supporting structure via the guide rail and the protrusion structures. The structure of the supporting structure is simple and may be easily installed, which may save the installation time and the human cost. As the supporting structures are arranged at two lateral sides of the display panel, the transparent display panel and the double-sided display panel may be effectively fixed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display device, comprising:
a display panel comprising two protrusion structures on the two sides perpendicular to a horizontal direction;
the display device comprises two supporting structures supporting and fixing the display panel;
wherein the display panel is a single-side display panel, a transparent display panel or a double-sided display panel, and a length of the protrusion structure is configured in accordance with a center height of the display panel;
the supporting structure comprises a base and a guiding rail on the base, the guiding rail engages with the protrusion structure, and the guiding rail covers the protrusion structure being inserted along the guiding rail to latch the display panel within the supporting structure.

2. The display device claimed in claim 1, wherein the base and the guiding rail are integrally formed.

3. The display device claimed in claim 1, wherein cross-sections of the guiding rail and the protrusion structure are regular polygon.

4. The display device claimed in claim 3, wherein cross-sections of the guiding rail and the protrusion structure are rectangular-shaped.

5. The display device claimed in claim 1, wherein cross-sections of the guiding rail and the protrusion structure are inverted-trapezium-shaped.

6. The display device claimed in claim 1, wherein cross-sections of the guiding rail and the protrusion structure are hemicycle-shaped.

7. The display device claimed in claim 1, wherein cross-sections of the guiding rail and the protrusion structure are circular.

8. The display device claimed in claim 1, wherein a guiding structure is arranged in a bottom of the display panel, wherein the guiding structure is arranged close to a location of the protrusion structure.

9. A display device, comprising:
a display panel, wherein the display panel comprising two protrusion structures on the two sides perpendicular to a horizontal direction;
the display device comprises two supporting structures supporting and fixing the display panel;
wherein the supporting structure comprises a base and a guiding rail on the base, the guiding rail engages with the protrusion structure, and the guiding rail covers the protrusion structure being inserted along the guiding rail to latch the display panel within the supporting structure.

10. The display device claimed in claim 9, wherein a length of the protrusion structure is configured in accordance with a center height of the display panel.

11. The display device claimed in claim 9, wherein the base and the guiding rail are integrally formed.

12. The display device claimed in claim 9, wherein cross-sections of the guiding rail and the protrusion structure are regular polygon.

13. The display device claimed in claim 12, wherein cross-sections of the guiding rail and the protrusion structure are rectangular-shaped.

14. The display device claimed in claim 9, wherein cross-sections of the guiding rail and the protrusion structure are inverted-trapezium-shaped.

15. The display device claimed in claim 9, wherein cross-sections of the guiding rail and the protrusion structure are hemicycle-shaped.

16. The display device claimed in claim 9, wherein cross-sections of the guiding rail and the protrusion structure are circular.

17. The display device claimed in claim 9, wherein a guiding structure is arranged in a bottom of the display panel, wherein the guiding structure is arranged close to a location of the protrusion structure.

18. The display device claimed in claim 9, wherein the display panel is a single-side display panel, a transparent display panel or a double-sided display panel.
